(19) United States
(12) Patent Application Publication
(10) Pub. No.: US 2008/0163827 A1
(43) Pub. Date: Jul. 10, 2008

(54) Collar Saddle for Positioning a Device Carried by an Animal on the Animal's Neck

(75) Inventor: Brent A. Goetzl, Orinda, CA (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/621,348

(22) Filed: Jan. 9, 2007

(51) Int. Cl. A01K 29/00; A01K 27/00

(52) U.S. Cl. 119/712; 119/859; 119/863

(57) ABSTRACT

Described is a collar saddle device for maintaining the position of a device carried by an animal at the top of the animal's neck. The collar saddle device includes a saddle, a carried device, and a collar. The saddle is fixedly secured to the collar and includes a contoured portion that is structured to substantially parallel the contour of the top of the animal's neck. The carried device is fixedly secured to the collar and is situated proximately to the saddle. The contoured portion of the saddle matingly receives the top of the animal's neck to the extent that the saddle does not slide or rotate from the top of the animal's neck. Because the saddle and the carried device are situated proximately along the collar, the position of the carried device is maintained at the top of the animal's neck.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a device for maintaining the position of a another device carried by an animal at the top of the animal's neck. More particularly, this invention pertains to a device that is fixedly secured to a collar and is structured to substantially parallel the contour of the top of the animal's neck such that when situated at the top of the animal's neck, the collar, and any device attached thereto, does not rotate about the animal's neck.

2. Description of the Related Art

Many animal training systems include a device that is carried by an animal. Typically, this device is carried by the animal by way of a pet collar. More specifically, the device is secured to the pet collar, and the pet collar is secured to the animal. The device carried by the animal is typically in communication with another component of the animal training system. For example, the carried device is in communication with the perimeter antenna of an electronic pet confinement system, a handheld stimulus delivery device, or an animal locating device. In other words, the carried device transmits and/or receives information regarding the behavior of the animal. For example, when a sporting dog is equipped with an animal locating device, the device carried by the dog transmits audible and/or radio signals to indicate the location of the dog within the sporting field. To maximize the communication capabilities of the dog locating device, the carried device must be positioned at the top of the dog's neck, so the dog's body and other surrounding elements, such as earth, water, and brush, do not weaken and block the transmitted signals. However, as the dog runs, jumps, turns, and otherwise moves through the sporting field, the mass of the carried device in conjunction with forces resulting from the dog's movement and the force of gravity causes the carried device to slip from the top of the dog's neck and to rotate to the dog's throat. At the dog's throat, the dog's body and environmental elements interfere with transmitted signals, reducing the communication capabilities of the dog locating device.

Conventional devices for maintaining the position of a carried device at the top of an animal's neck are limited to securing a counterweight to the pet collar. More specifically, the counterweight is secured to the pet collar at the animal's throat. The counterweight has a weight that is greater than that of the carried device such that the force of gravity maintains the counterweight at the animal's throat. Because the carried device is secured to the pet collar at the top of the animal's neck, the carried device is maintained at the top of the animal's neck. This conventional method is limited in that the animal must carry the additional weight of the counterweight, which is an unnecessary stress on the animal. Additionally, the counterweight is not effective in countering the lateral forces generated by the animal's movement that cause the carried device to slip from the top of the animal's neck.

### BRIEF SUMMARY OF THE INVENTION

In accordance with the various features of the present invention there is provided a collar saddle device for maintaining the position of a device carried by an animal at the top of the animal's neck. The collar saddle device includes a saddle, a carried device, and a collar. The saddle is fixedly secured to the collar and includes a contoured portion that is structured to substantially parallel the contour of the top of the animal's neck. The carried device is fixedly secured to the collar and includes any device adapted to be carried by the animal. The collar is secured to the animal such that the animal carries the saddle and the carried device. The saddle is situated proximately to the carried device along the collar. Additionally, the saddle is situated such that the contoured portion of the saddle is in physical contact with the top of the animal's neck. The contoured portion of the saddle matingly receives the top of the animal's neck to the extent that the saddle does not slide or rotate from the top of the animal's neck. Because the saddle and the carried device are situated proximately along the collar, the position of the carried device is maintained at the top of the animal's neck.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1a is a perspective view of one embodiment of the collar saddle device in accordance with the various features of the present invention;

FIG. 1b is an exploded view of the collar saddle device of FIG. 1a; and

FIG. 2 illustrates the collar saddle device of FIG. 1a secured to an animal in accordance with the various features of the present invention.

### DETAILED DESCRIPTION OF THE INVENTION

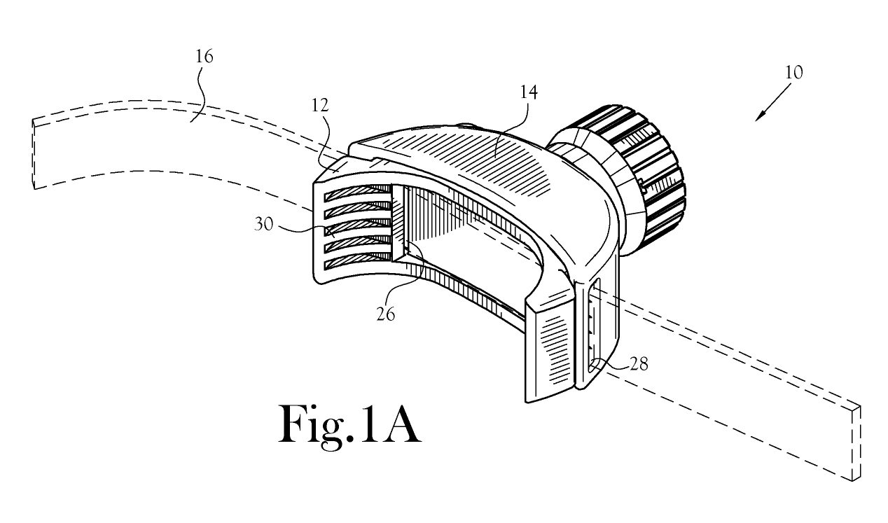

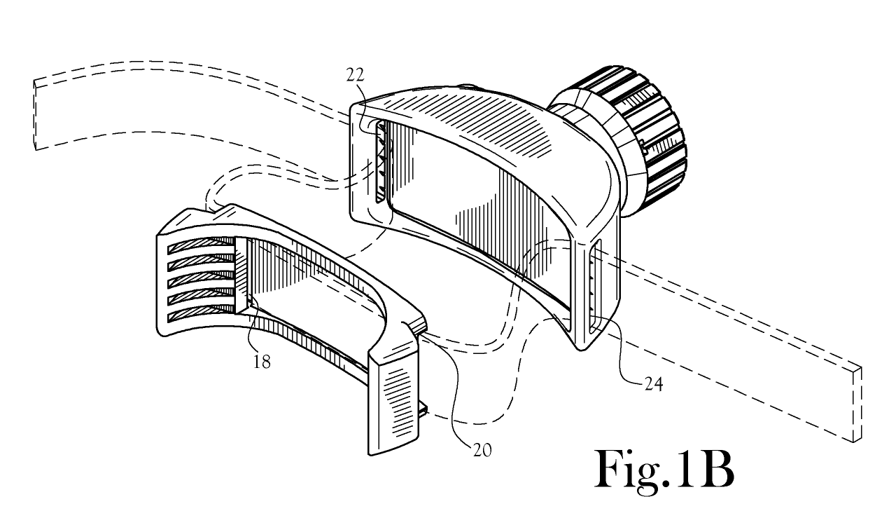

One embodiment of a collar saddle device for maintaining the position of a device carried by an animal at the top of the animal's neck and constructed in accordance with the various features of the present invention is illustrated generally at 10 in FIG. 1. The collar saddle device 10 includes a saddle, a carried device, and a collar. The saddle is fixedly secured to the collar and includes a contoured portion that is structured to substantially parallel the contour of the top of the animal's neck. The carried device is fixedly secured to the collar and includes any device adapted to be carried by the animal. The collar is secured to the animal such that the animal carries the saddle and the carried device. The saddle is situated proximately to the carried device along the collar. Additionally, the saddle is situated such that the contoured portion of the saddle is in physical contact with the top of the animal's neck. The contoured portion of the saddle matingly receives the top of the animal's neck to the extent that the saddle does not slide or rotate from the top of the animal's neck. Because the saddle and the carried device are situated proximately along the collar, the position of the carried device is maintained at the top of the animal's neck.

FIG. 1a illustrates one embodiment the collar saddle device 10 in accordance with the various features of the present invention. In the illustrated embodiment, the collar saddle device 10 includes a saddle 12, a carried device 14, and a collar 16. The saddle 12 is fixedly secured to the collar 16. Fixedly secured does not require that the saddle 12 be incapable of moving along the collar 16 such that, for example, the trainer cannot adjust the position of the saddle 12 along the collar 16. Fixedly secured merely requires that the saddle 12 not shift along the collar 16 after being employed, namely after the collar 16 is secured to the animal and the trainer has adjusted the saddle 12 to his satisfaction. The saddle 12 includes a contoured portion 30. The contoured portion 30 is structured to substantially parallel the contour of the top of the animal's neck. The top of the animal's neck is the portion of the animal's neck that is opposite the animal's throat. The top of the animal's neck is also commonly referred to as the back of the animal's neck. Because the contoured portion 30 is structured to substantially parallel the contour of the top of the animal's neck, the saddle 12 is secured to the collar 16 such that when the collar 16 is secured to the animal, the contoured portion 30 is in physical contact with the animal at the top of the animal's neck. More specifically, the contoured portion 30 of the saddle 12 matingly receives the contour of the top of the animal's neck. Because the contoured portion 30 of the saddle 12 matingly receives the top of the animal's neck, the saddle 12 does not slide or rotate from the top of the animal's neck when the animal runs, jumps, or otherwise moves. Additionally, in the illustrated embodiment, the contoured portion 30 is constructed of an elastomeric material. The elastomeric material provides a raised frictional force between the contoured portion 30 of the saddle 12 and the animal's neck to further secure the saddle 12 from sliding from the top of the animal's neck. It should be noted that the contoured portion 30 constructed of a material that provides a raised frictional force other than an elastomeric material is achievable without departing from the scope or spirit of the present invention. It should also be noted that the contoured portion 30 constructed of a material that does not provide a raised frictional force is achievable without departing from the scope or spirit of the present invention.

The carried device 14 includes any device adapted to be carried by the animal, such as those used for training, monitoring, or otherwise controlling an animal. For example, the carried device 14 includes the receiver for an electronic pet confinement system, the receiver for a handheld stimulus delivery system, and an animal locating device. In the illustrated embodiment, the carried device 14 is an animal locating device for indicating the position of a sporting dog in the sporting field by way of an audible signal transmitted by the carried device 14 and by way of a radio signal transmitted by the carried device 14. Those skilled in the art will recognize that the carried device 14 can be a device other than an animal locating device without departing from the scope or spirit of the present invention. The carried device 14 is fixedly secured to the collar 16, fixedly secured being defined above. Additionally, the carried device 14 is situated proximately to the saddle 12 along the collar 16 such that the carried device 14 is positioned at the top of the animal's neck.

FIG. 1b illustrates an exploded view of the illustrated embodiment of the collar saddle device 10 of FIG. 1a in accordance with the various features of the present invention. In the illustrated embodiment, the saddle 12 includes a first saddle throughway 18 and a second saddle throughway 20. The carried device 14 includes a first carried device throughway 22 and a second carried device throughway 24. The saddle 12 is coupled with the carried device 14 such that the first saddle throughway 20 aligns with the first carried device throughway 22 to define a first collar throughway 26. Similarly, the second saddle throughway 20 aligns with the second carried device throughway 24 to define a second collar throughway 28. The first collar throughway 26 and the second collar throughway 28 are adapted to receive the collar 16 such that when the collar 16 is positioned within the first collar throughway 26 and the second collar throughway 28, the coupled saddle 12 and carried device 14 are secured to the collar 16 as depicted in FIG. 1a.

It should be noted that various configurations where the saddle 12 and the carried device 14 are situated proximately along the collar 16, other than where the saddle 12 is coupled with the carried device 14, are achievable without departing from the scope or spirit of the present invention. It should also be noted that the saddle 12 and carried device 14 can be independently secured to the collar 16 without departing from the scope or spirit of the present invention. Additionally, it should be noted that the saddle 12 and the carried device 14 can be secured to the collar 16 without utilizing defined throughways adapted to receive the collar 16 without departing from the scope or spirit of the present invention. It should also be noted that the saddle 12 need not be directly fixedly secured to the collar 16 to remain within the scope and spirit of the present invention. For example, in one embodiment of the collar saddle device 10, the saddle 12 is mechanically compressed between the carried device 14, which is fixedly secured to the collar 16, and the top of the animal's neck.

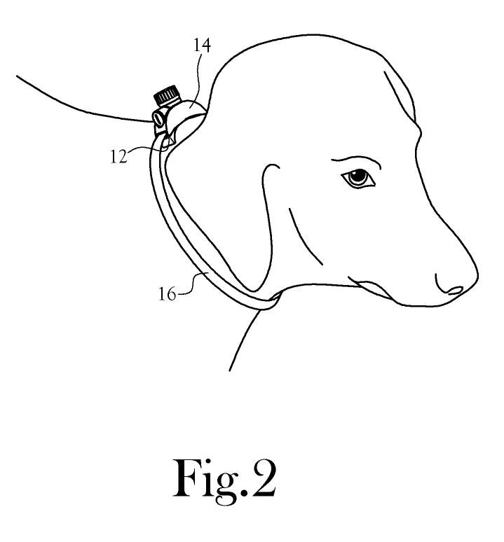

FIG. 2 is a perspective view of the illustrated embodiment of the collar saddle device 10 secured to the animal in accordance with the various features of the present invention. In the illustrated embodiment, the animal is a sporting dog and, as previously discussed, the carried device 14 is an animal locating device. As the animal makes its way in the sporting field, it walks, trots, runs, turns, jumps, and even swims. Additionally, as the animal makes its way, it disappears from the trainer's line of sight. As a result, the trainer depends on the carried device 14 to transmit information regarding the animal's location by way of the audible signal and the radio signal. Because the contoured portion 30 of the saddle 12 matingly receives the contour of the top of the animal's neck, the saddle 12 does not slide from the top of the animal's neck. Because the saddle 12 is fixedly secured to the collar 16, the collar 16 does not rotate about the animal's neck. And because the carried device 14 is fixedly secured to the collar 16, the carried device 14 does not slide or rotate from the top of the animal's neck. In other words, the saddle 12 maintains the position of the carried device 14 at the top of the animal's neck such that the carried device 14 does not slide from the top of the animal's neck and rotate to the animal's throat. Because the saddle 12 maintains the position of the carried device 14 at the top of the animal's neck, the audible and radio signals transmitted by the carried device 14 are not impeded by the animal's body, brush when the animal is in a wooded area, or water when the animal is swimming. Consequently, the saddle 12 facilitates the realization of the designed potential of the communication capabilities of the carried device 14.

From the foregoing description, those skilled in the art will recognize that a device for maintaining the position of another device at the top of an animal's neck offering advantages over the prior art has been provided. The device provides a saddle that is fixedly secured to a collar and structured to receive the top of the animal's neck such that the saddle, and consequently the collar, does not rotate about the animal's neck.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

1. A collar saddle device for maintaining the position of a carried device at the top of an animal's neck, said collar saddle device comprising:
a collar, said collar being secured about the animal's neck;
a saddle, said saddle fixedly secured to said collar, said saddle including a contoured portion that is substantially parallel to the contour of the top of the animal's neck, the contoured portion of said saddle being situated in physical contact with the top of the animal's neck; and
a carried device, said carried device fixedly secured to said collar, said carried device secured to said collar such that said carried device is situated proximate to said saddle along said collar.

2. The collar saddle device of claim 1 wherein the contoured portion of said saddle is constructed of a material that generates a raised frictional force between the contoured portion and the top of the animal's neck.

3. The collar saddle device of claim 2 wherein the contoured portion of said saddle is constructed of an elastomeric material.

4. The collar saddle device of claim 1 wherein the contoured portion of said saddle is constructed of a material that generates a frictional force that further maintains the position of said carried device at the top of the animal's neck.

5. The collar saddle device of claim 1 wherein said saddle is coupled with said carried device.

6. The collar saddle device of claim 1 wherein said carried device is in communication with an animal training system.

7. The collar saddle device of claim 1 wherein said carried device is an animal locator device.

8. The collar saddle device of claim 1 wherein said carried device is a component of an animal training system.

9. A collar saddle device for maintaining the position of a carried device at the top of an animal's neck, said collar saddle device comprising:
a saddle, said saddle being carried by the animal, said saddle including an upper portion, the upper portion being structured to couple a carried device such that the carried device is fixedly coupled to the upper portion of said saddle, said saddle including a lower portion, the lower portion being structured to substantially follow the contour of the top of the animal's neck, the lower portion being disposed in physical contact with the top of the animal's neck.

10. The collar saddle device of claim 9 where said saddle is fixedly secured to a collar.

11. The collar saddle device of claim 9 wherein the upper portion of said saddle is in a temporary fixed relationship with a carried device.

12. The collar saddle device of claim 9 wherein the upper portion of said saddle is in a permanent fixed relationship with a carried device.

13. (canceled)

14. A collar saddle device for maintaining the position of a carried device at the top of an animal's neck, said collar saddle device comprising:
a collar, said collar secured to the animal such that the animal carries the collar;
a saddle, said saddle fixedly secured to said collar, said saddle structured to matingly receive the contour of the top of the animal's neck, said saddle situated along said collar such that said saddle is in physical contact with the top of the animal's neck such that the portion of said saddle that is structured to matingly receive the contour of the top of the animal's neck matingly receives the contour of the top of the animal's neck; and
a carried device, said carried device fixedly secured to said collar, said carried device situated along said collar proximately to said saddle.

15. The collar saddle device of claim 14 wherein said carried device is secured to said saddle.

16. The collar saddle device of claim 11 wherein the carried device is fixedly secured to a collar.

17. The collar saddle device of claim 12 wherein the carried device is fixedly secured to a collar.
